(19) United States
(12) Patent Application Publication
(10) Pub. No.: US 2009/0178313 A1
(43) Pub. Date: Jul. 16, 2009

(54) METHOD AND APPARATUS FOR BEVERAGE IDENTIFICATION

(76) Inventor: Michael McManigal, Pembroke Pines, FL (US)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 12/013,872

(22) Filed: Jan. 14, 2008

(51) Int. Cl. G09F 3/00; B65D 25/00

(52) U.S. Cl. 40/310; 116/201; 116/200; 215/386; 220/694; 40/665; 116/307

(57) ABSTRACT

The present invention provides a beverage identification system, including a first beverage identification element positionable about a beverage container; and a second beverage identification element wearable on a person, where the first and second beverage identification elements are visually substantially identical to one another. Each of the first and second beverage identification elements may define a ring-shaped body, and the first and second identification elements may be elastic. In addition, each of the first and second beverage identification elements may be the same color, and/or each of the first and second beverage identification elements may have substantially identical patterns thereon. Further, the first and second beverage identification elements may be removably coupled to each other.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a method and apparatus for beverage identification.

### BACKGROUND OF THE INVENTION

At a typical party or social event, numerous individuals often drink soda, beer, or other beverages out of a cup or prepackaged beverage container. As routinely happens, a person will set their drink down among a myriad of other similar cups or beverage containers belonging to other partygoers. As a result, the individual may subsequently have difficulty identifying which beverage belongs to whom, resulting in either an abandonment of the drink and leading to waste, or causing the accidental consumption of a drink belonging to someone else. Although consuming a beverage of another may simply seem mildly inappropriate given the circumstances, such consumption may also carry a risk of exposure to a contagious illness.

Traditional methods of identifying beverages at a party include using a marker to write directly on the beverage or placing an adhesive label on the outside of the beverage. However, the writing placed directly on the beverage could smear or rub-off, especially if condensation forms on the outer surface of the beverage. Similarly, an adhesive label could fall off or otherwise become detached from a beverage container, leaving a sticky residue on the beverage while also failing to identify which beverage belongs to whom.

In light of the above problems, it would be advantageous to provide a method and system providing an individual with the ability to readily identify his or her own beverage among numerous similar beverages in order to avoid accidental consumption of a drink belonging to someone else and to further avoid waste. It would further be advantageous to provide for beverage identification which would not be susceptible to smearing or wearing off.

### SUMMARY OF THE INVENTION

The present invention advantageously provides a method and apparatus for beverage identification which allows an individual to readily identify his or her own beverage among numerous similar beverages in order to avoid accidental consumption of a drink belonging to someone else and to further avoid waste.

In an exemplary embodiment, the present invention provides a beverage identification system, including a first beverage identification element positionable about a beverage container; and a second beverage identification element wearable on a person, where the first and second beverage identification elements are visually substantially identical to one another. Each of the first and second beverage identification elements may define a ring-shaped body, and the first and second identification elements may be elastic. In addition, each of the first and second beverage identification elements may be the same color, and/or each of the first and second beverage identification elements may have substantially identical patterns thereon. Further, the first and second beverage identification elements may be removably coupled to each other.

The present invention also provides a beverage identification system, including a plurality of paired beverage identification elements, where each pair includes a first beverage identification element positionable about a beverage container and a second beverage identification element wearable on a person, where the first and second beverage identification elements of each pair are visually substantially identical to one another; and where each pair of the plurality of beverage identification elements is visually distinguishable from the other pairs. Each of the first and second beverage identification elements may define a ring-shaped body and may be elastic. In addition, each pair of beverage identification elements may have a distinct color different from the others of the plurality and/or each pair of beverage identification elements may have a distinct pattern thereon different from the others of the plurality.

The present invention also provides a method for identifying a beverage, including mounting a first beverage identification element onto a beverage container; positioning a second beverage identification element on a person, where the first and second beverage identification elements are visually substantially identical to one another; and identifying a beverage based at least in part upon comparing the first and second beverage identification elements to each other. The method may also include detaching the first beverage identification element from the second beverage identification element. Mounting the first beverage identification element onto a beverage container may include deforming the first beverage identification element, and positioning the second beverage identification element on a person may include deforming the second beverage identification element.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates an embodiment of an apparatus for beverage identification in accordance with the present invention;

FIG. 2 shows an alternative embodiment of an apparatus for beverage identification in accordance with the present invention;

FIG. 3 shows an exemplary system for beverage identification in accordance with the present invention; and

FIG. 4 depicts an exemplary use of an apparatus for beverage identification in accordance with the present invention.

### DETAILED DESCRIPTION OF THE INVENTION

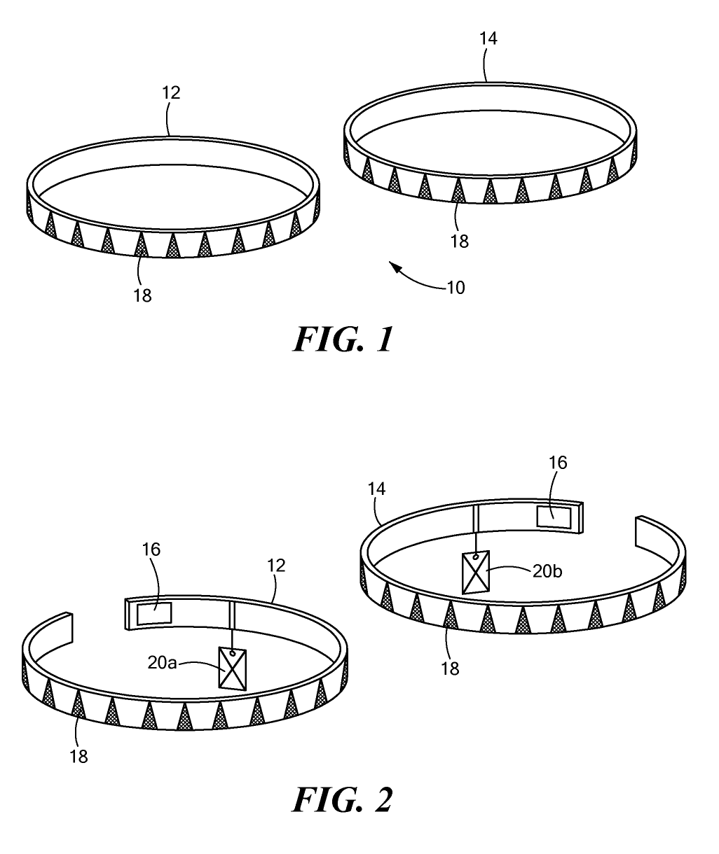

The present invention advantageously provides a method and apparatus for beverage identification which allows an individual to readily identify his or her own beverage among numerous similar beverages in order to avoid accidental consumption of a drink belonging to someone else and to further avoid waste. Now referring to FIGS. 1 and 2, an exemplary embodiment of the present invention provides a beverage identification system, generally designated as 10, having a first beverage identification element 12 that is positionable about and/or mountable on a beverage container, such as a bottle, can, cup or the like, and a second beverage identification element 14 that is wearable or otherwise positionable about a person and/or article of clothing. In particular, each of the first and second beverage identification elements may generally have a ring-like shape, or alternatively, may be in the form of an open-loop with a fastening element 16 for securing the two open ends of loop to each other, where the fastening element 16 may include Velcro, adhesive, snaps, or the like. In addition, the first and second identification elements 12, 14 may be constructed from a resilient and/or elastic flexible material, including various plastics or rubber, such that the identification elements are stretchable or deformable to achieve their positioning on a beverage container, onto an article of clothing or a person.

The first and second beverage identification elements 12, 14 may be substantially visually identical to one another to aid in matching the first and second identification elements to one another to subsequently identify a beverage, as discussed in more detail below. For example, the paired first and second identification elements may include a unique, visually identifying characteristic 18 such as matching color, text, size, patterns, or the like, that is common to both the first and second identification elements. The visually identifying characteristic 18 generally operates to identify the first and second identification elements as a pair, and thus can be used to identify or otherwise ascertain the ownership of a beverage container. Such text, color, patterns, etc. may be positioned about an outer surface of the first and second identification elements, making the distinguishing characteristics readily visible. An alternative embodiment of the unique identifier 18 may include a first identification token 20a affixed to the first identification element 12, while a similar second identification token 20b may be affixed to the second identification element 14, thereby identifying the first and second beverage identification elements as a matched pair. The identification tokens 20a, 20b may have virtually any shape or orientation, and provide for the unique identification and ability to distinguish one pair of identification elements from another.

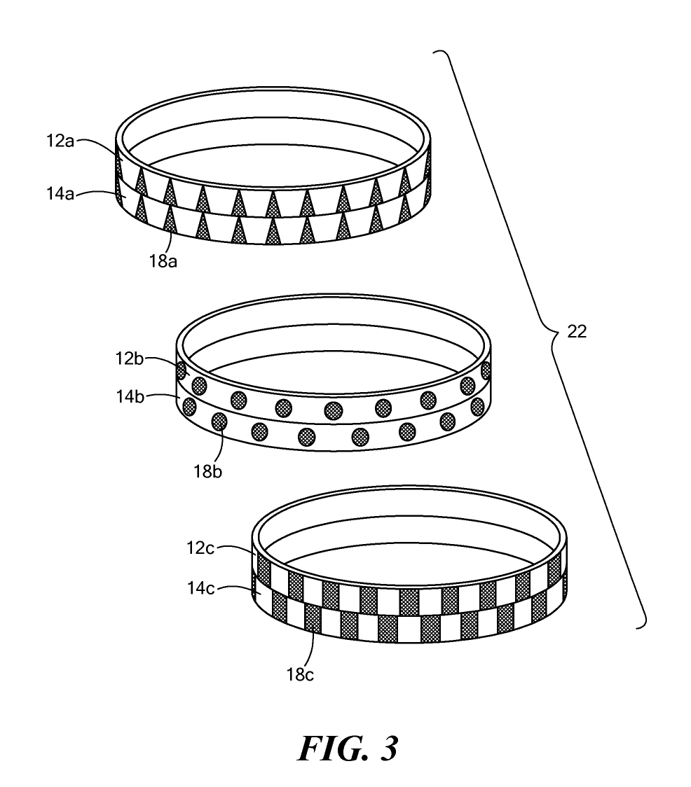

As shown in FIG. 3, the beverage system of the present invention may include a plurality 22 of paired first 12a, 12b, 12c and second 14a, 14b, 14c beverage identification elements for identifying multiple beverage containers of multiple people. Each of the first beverage identification elements may be positionable about and/or mountable on a beverage container, while each second beverage identification element may be wearable or otherwise positionable about a person and/or article of clothing. Furthermore, each pair of first and second beverage identification elements may include unique visual characteristics 18a, 18b, 18c distinct from the other pairs of the plurality 22. For example, each matched pair may have a distinct color, pattern, text, or the like that is unique and distinguishable from the others. As such, where multiple matched pairs of beverage identification elements are present, each pair of first and second identification elements may be readily distinguished from any additional pairs of first and second identification elements to thus provide for beverage identification when in use.

As discussed above, the first and second beverage identification elements may comprise a paired set to facilitate beverage identification, and as such, the first and second beverage identification elements may be removably coupled to or otherwise engaged to one another prior to use. The removable coupling may be achieved by joining the two beverage identification elements such that they are easily removed from each other when a small force is applied to either identification element. For example, the first and second beverage identification elements may be bound, welded, or otherwise molded to one another with a breakable seam, adhesive or other releasable or removable coupling mechanism. Removably coupling a matched pair of first and second beverage identification elements facilitates ease of use and selection of the pairs where there is a plurality of paired beverage identification elements having varied unique identifiers present.

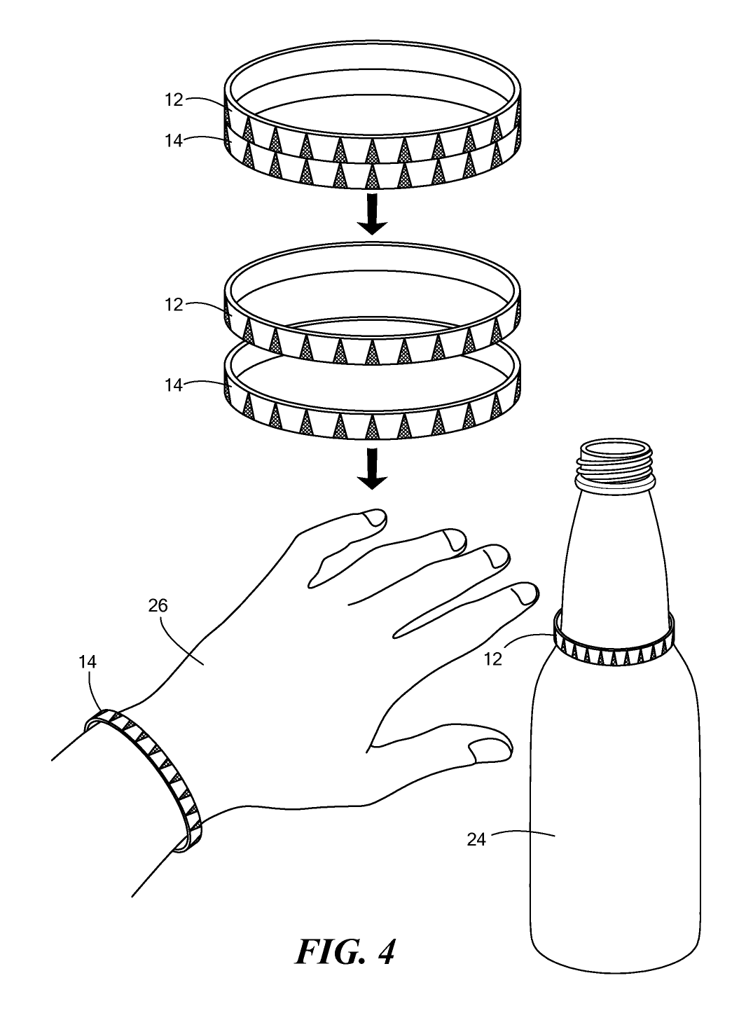

Now referring to FIG. 4, in a method of exemplary use of the beverage identification system 10 of the present invention, one or more visually matched pairs of first and second beverage identification elements 12, 14 may be provided. Should the first and second beverage identification elements be removably coupled to one another, an individual may primarily disengage the coupling between the first identification element 12 and the second identification element 14. The first identification element 12 may then be affixed to a beverage container 24 such as a bottle, can, or cup. In an embodiment where the first and second identification elements have a resilient ring-like shape, the first identification may be expanded to pass over an outer surface of the beverage container 24, with the resilient nature of the first identification element 12 resulting in a frictional attachment to the beverage container 24. The second identification element 14 is then affixed to a portion 26 of the individual, i.e., about the wrist, purse, attached onto clothing, in the pocket, etc., through a similar elastic attachment. Alternatively, should the first and second identification elements have an open-loop construction, the open ends of each identification element can be secured to each other upon positioning the identification elements about the beverage 24 and wrist or article of clothing 26, respectively. Where a plurality 22 of matched pairs of identification elements is provided, multiple users may similarly disengage a matched pair form each other, and subsequently place the first and second beverage identification elements onto a beverage container and on their person or article of clothing, respectively.

Once the beverage identification elements are positioned, the beverage container 24 having the first identification element 12 can easily and readily be identified and distinguished from other beverages by referring to and matching the unique visual characteristic 18 of the first identification element 12 affixed to the beverage to that of the second identification element 14 affixed to the person 26. In other words, an individual may identify their drink by finding the beverage container 24 having the beverage identification element substantially visually identical to the beverage identification element on their person. Where a plurality 22 of identification elements is present, as described above, each pair may have visual characteristics different and distinguishable from the remaining pairs of the plurality, thus allowing multiple people to identify their respective beverages. As a result, use of the beverage identification system 10 reduces the likelihood that a beverage will be lost or confused with the beverages of others.

While the above identification apparatus and method has been described with respect to use for beverage identification, the present invention would be equally applicable to numerous objects in order to indicate ownership. For example, the present invention could be applied to distinguish items such as cellular phones, portable music devices, PDAs, etc.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A beverage identification system, comprising:
a first beverage identification element positionable about a beverage container; and
a second beverage identification element wearable on a person, wherein the first and second beverage identification elements are visually substantially identical to one another.

2. The system according to claim 1, wherein each of the first and second beverage identification elements define a ring-shaped body.

3. The system according to claim 2, wherein the first and second identification elements are elastic.

4. The system according to claim 1, wherein each of the first and second beverage identification elements are the same color.

5. The system according to claim 1, wherein each of the first and second beverage identification elements have substantially identical patterns thereon.

6. The system according to claim 1, wherein the first and second beverage identification elements are removably coupled to each other.

7. A beverage identification system, comprising:
a plurality of paired beverage identification elements, wherein each pair includes a first beverage identification element positionable about a beverage container and a second beverage identification element wearable on a person, wherein the first and second beverage identification elements of each pair are visually substantially identical to one another; and
wherein each pair of the plurality of beverage identification elements is visually distinguishable from the other pairs.

8. The system according to claim 7, wherein each of the first and second beverage identification elements define a ring-shaped body.

9. The system according to claim 7, wherein each of the first and second identification elements are elastic.

10. The system according to claim 7, wherein each pair of beverage identification elements has a distinct color different from the others of the plurality.

11. The system according to claim 7, wherein each pair of beverage identification elements has a distinct pattern thereon different from the others of the plurality.

12. The system according to claim 7, wherein the first and second beverage identification elements of each pair are removably coupled to each other.

13. A method for identifying a beverage, comprising:
mounting a first beverage identification element onto a beverage container;
positioning a second beverage identification element on a person, wherein the first and second beverage identification elements are visually substantially identical to one another; and
identifying a beverage based at least in part upon comparing the first and second beverage identification elements to each other.

14. The method according to claim 13, further comprising detaching the first beverage identification element from the second beverage identification element.

15. The method according to claim 13, wherein mounting the first beverage identification element onto a beverage container includes deforming the first beverage identification element.

16. The method according to claim 13, wherein positioning the second beverage identification element on a person includes deforming the second beverage identification element.

17. The method according to claim 13, wherein each of the first and second beverage identification elements define a ring-shaped body.

18. The method according to claim 13, wherein each of the first and second beverage identification elements are the same color.

19. The method according to claim 13, wherein each of the first and second beverage identification elements have substantially identical patterns thereon.
